(19) United States
(12) Patent Application Publication
(10) Pub. No.: US 2008/0235953 A1
(43) Pub. Date: Oct. 2, 2008

(54) Sheath structure of stationery scissors

(76) Inventor: Kuang-Pin Wang, Wurih Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/730,402

(22) Filed: Apr. 2, 2007

(51) Int. Cl. B26B 29/00

(52) U.S. Cl. 30/151

(57) ABSTRACT

A sheath structure of stationery scissors has scissors and a sheath. One end of the sheath is provided with holding parts for holding fixing parts at the pivotal intersection of the scissors, enclosing the scissors within the sheath. The sheath is further provided with a fixing assembly that slides and positions inside the sheath. The fixing assembly is mounted with a knife, so that the knife is extended from or retracted into the sheath by the fixing assembly. Such a sheath structure can be used to cover the scissors and be used as a knife as well. Therefore, it has double functions at a lower production cost.

### BACKGROUND OF THE INVENTION

1. Field of Invention

The invention relates to a sheath structure of stationery scissors and, in particular, to a sheath structure that encloses scissors and fixes at its base and can serve as a utility knife.

2. Related Art

FIG. 7 shows the usual stationery scissors and their sheath. The structure of the usual scissors 90 has two shears, which are combined using a rivet 91. The sheath 80 in the drawing encloses the scissors to their base and fixes with the friction. However, such a fixing method relies on the friction. Therefore, the sheath 80 gradually wears off and eventually cannot tightly enclose the scissors after long time use.

A common utility knife is shown in FIG. 8. It has a knife frame 70 with one end provided with a cap 71. The cap covers a sliding base 72 for fixing the knife. The sliding base can slide and position inside the knife frame 70, thereby extending or retracting the knife. However, such utility knifes have only a single function.

Therefore, it is an objective of the invention to provide a multi-functional knife set with a low production cost.

### SUMMARY OF THE INVENTION

The invention discloses a sheath structure of stationery scissors. Fixing parts are provided on opposite sides of the pivotal intersection of the scissors. One end of the sheath is formed with holding parts that matches with the fixing parts. When the sheath is put on the scissors, the holding parts hold the fixing parts, preventing the scissors from hurting users.

Another objective of the invention is to reduce the material and production cost of the sheath. The sheath is provided with a fixing assembly for mounting a knife. The fixing assembly can slide and position in the sheath. The fixing assembly can thus extend or retract the knife. The sheath thus serves as a utility knife.

To achieve the above-mentioned objectives, the invention includes scissors with two fixing parts protruding from both sides of the pivotal intersection of the scissors, respectively, and a sheath with an accommodation space for enclosing the scissors. One end of the sheath is provided with holding parts that match with the fixing parts. The other end of the sheath is formed with an opening that restricts the motion of a knife within. A sliding groove for accommodating a fixing assembly is provided between the opening and the holding parts. The sliding groove has a positioning section in a wavy shape. One side of the fixing assembly is provided with an elastic chip. The elastic chip pushes against the positioning section of the sliding groove for positioning the fixing assembly. The fixing assembly can thus slide and position inside the sliding groove.

### BRIEF DESCRIPTION OF THE DRAWINGS

The invention will become more fully understood from the detailed description given herein below illustration only, and thus is not limitative of the present invention, and wherein:

FIG. 1 is an assembly diagram of the disclosed scissors and sheath;

FIG. 2 is a three-dimensional exploded view of the disclosed scissors and sheath;

FIG. 3 is a three-dimensional exploded view of the disclosed sheath;

FIG. 4 is a cross-sectional view showing the invention when the pivotal intersection of the scissors is caught by the sheath;

FIG. 5 shows how the sheath is used when the scissors and the sheath are combined according to the invention;

FIG. 6 shows how the disclosed sheath is used;

FIG. 7 shows the appearance of the conventional stationery scissors and their sheath; and

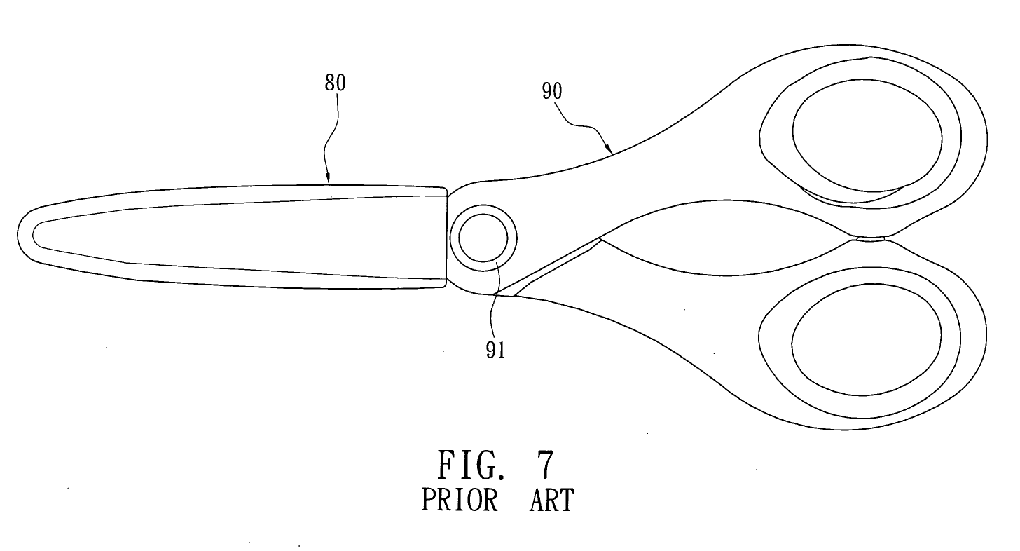

FIG. 8 shows the appearance of the conventional utility knife.

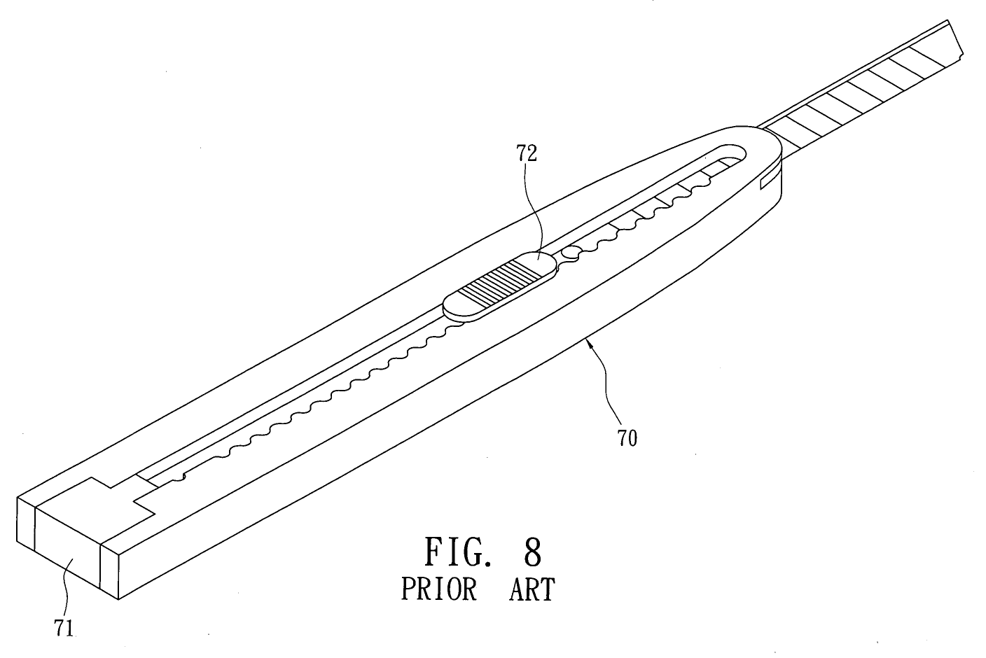

### DETAILED DESCRIPTION OF THE INVENTION

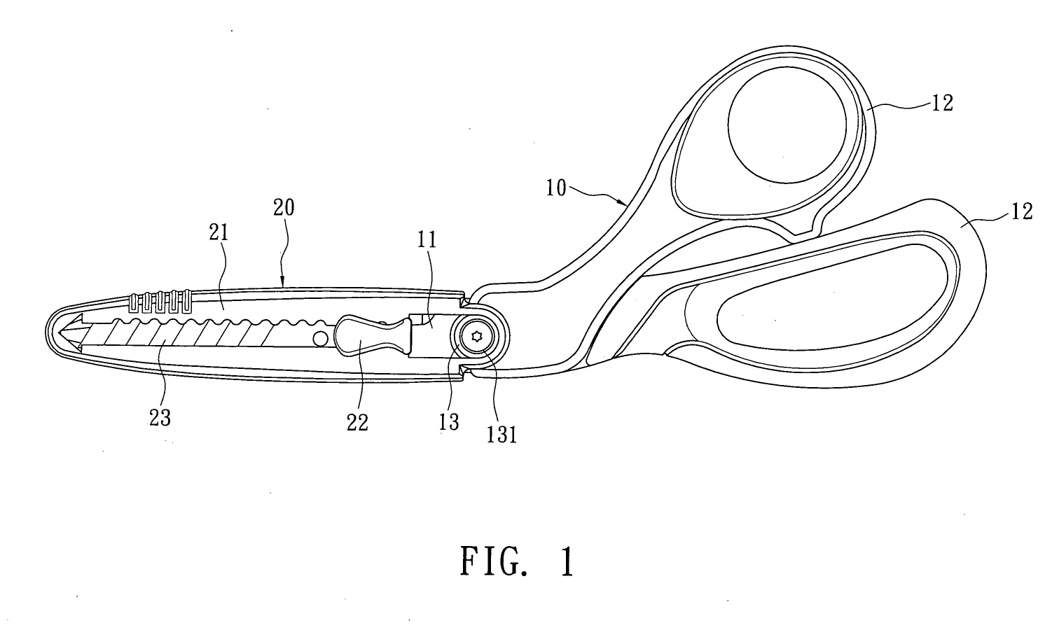

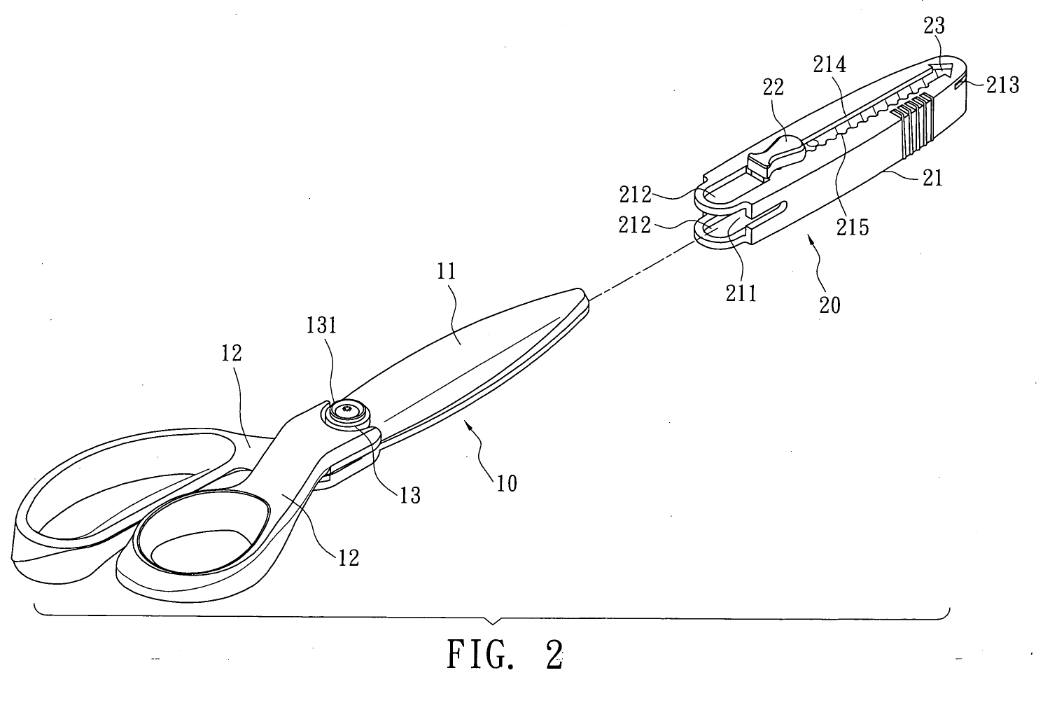

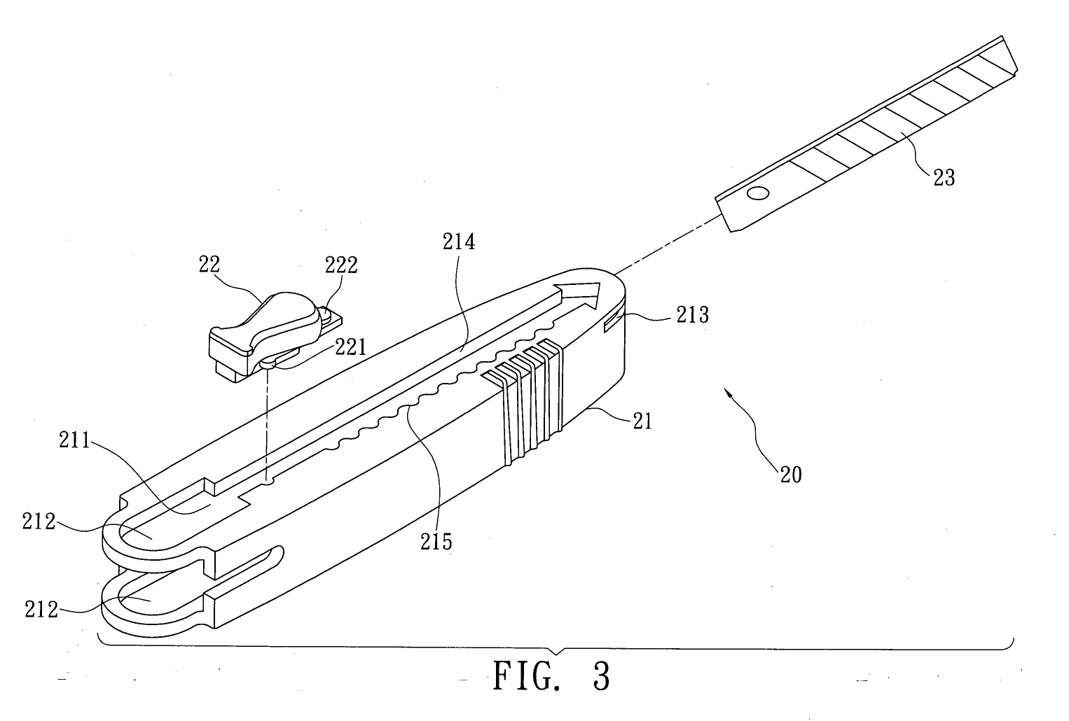

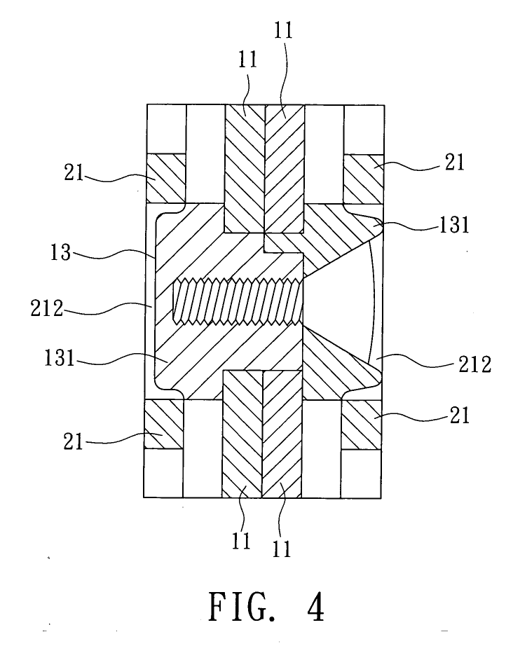

The present invention will be apparent from the following detailed description of a preferred embodiment, which proceeds with reference to the accompanying FIGS. 1 to 6, wherein the same references relate to the same elements. However, the invention is not restricted by the explicit example used herein.

Please refer to FIGS. 1 to 4. The invention includes scissors 10 and a sheath set 20. The scissors consists of two shears, each of which has a blade 11 and a holder 12. The shears are connected pivotally at the pivotal intersection. The pivotal intersection is a pivotal assembly 13 with a fixing part 131 protruding from it on each side.

The sheath set 20 has a sheath 21. The sheath 21 has an enclosing space 211 that matches with the base of the scissors 10. One end of the sheath is formed with holding parts 212 for holding the fixing parts 131. Each of the holding parts is a through hole. The closing end of the sheath is formed with an opening 213 that restricts the motion of a knife within 23. A sliding groove 214 for accommodating a fixing assembly 22 is provided between the opening 213 and the holding parts 212. The sliding groove 214 has a positioning section 215 in a wavy shape. One side of the fixing assembly 22 is provided with an elastic chip 221. The elastic chip 221 pushes against the positioning section 215 of the sliding groove 214 for positioning the fixing assembly 22. The fixing assembly 22 can thus slide and position inside the sliding groove 214. A protruding part 222 protrudes from the fixing assembly 22 for mounting a knife 23. The knife thus moves with the fixing assembly, extended from or retracted into the opening 213 of the sheath.

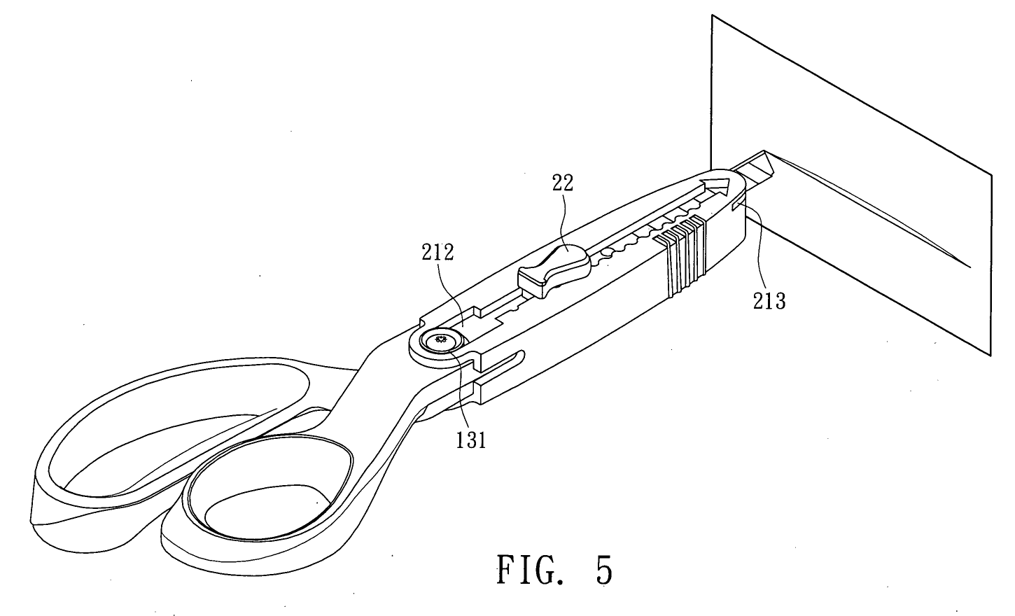

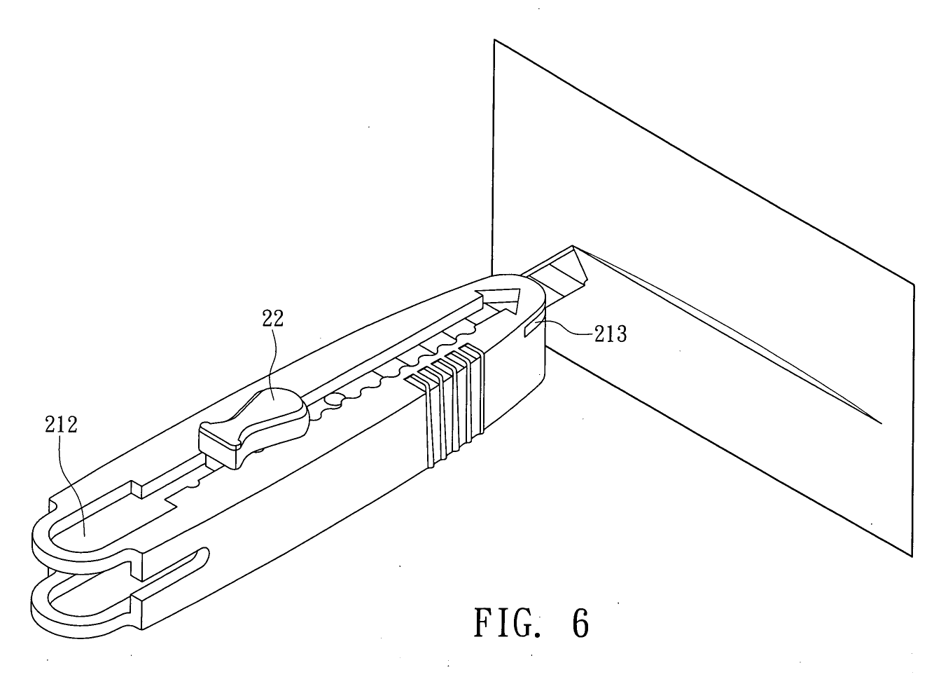

As shown in FIGS. 5 and 6, when the sheath uses its holding parts 212 (through holes) to hold the fixing part 131 of the scissors, it is not necessary to remove the sheath from the scissors. The user only needs to push the fixing assembly 22 in order to extend the knife out for use. Besides, the user can also take off the sheath as well. Therefore, the user can select to use the knife function or the shearing function of the sheath.

In the improved sheath structure, the holding parts (through holes) on one end of the sheath can readily enclose and hold the fixing parts on opposite sides of the scissors, preventing it from hurting users. Moreover, the sheath can function as a knife. Therefore, the invention has two functions. Therefore, the material and production cost can be reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A sheath structure of stationery scissors, comprising:
scissors;
a sheath, which has an accommodation space that encloses the scissors and holds onto the base thereof, and a fixing assembly for mounting a knife that slide and position inside the sheath.

2. The sheath structure of stationery scissors according to claim 1, wherein the sheath has an accommodation space for enclosing the scissors.

3. The sheath structure of stationery scissors according to claim 1, wherein the pivotal intersection of the scissors has a plurality of fixing parts and one end of the sheath is formed correspondingly with a plurality of holding parts that match with the fixing parts for combining the scissors and the sheath.

4. The sheath structure of stationery scissors according to claim 3, wherein the holding part is a through hole.

5. The sheath structure of stationery scissors according to claim 1, wherein the sheath has a sliding groove with a wavy shape and the fixing assembly has an elastic chip for positioning it the fixing assembly inside the sliding groove.

6. The sheath structure of stationery scissors according to claim 1, wherein the end of the sheath that is farther away from the holding parts is formed with an opening that restricts the motion of a knife within.

7. The sheath structure of stationery scissors according to claim 1, wherein the fixing assembly is mounted with a knife.

8. A sheath structure of stationery scissors, comprising:
scissors, whose pivotal intersection are formed with a fixing part on each side; and
a sheath, which has an accommodation space for enclosing the scissors, a plurality of holding parts matching with the fixing parts on one end, an opening that restricts the motion of a knife within on the other end, and a sliding groove for accommodating a fixing assembly between the opening and the holding parts;
wherein the sliding groove has a position section in a wavy shape, the fixing assembly has an elastic chip on one side, and the elastic chip pushes against the positioning section of the sliding groove and positions the fixing assembly.

9. The sheath structure of stationery scissors according to claim 8, wherein the holding part is a through hole.

10. The sheath structure of stationery scissors according to claim 8, wherein the fixing assembly is provided with a knife.
